(19) United States
(12) Patent Application Publication
(10) Pub. No.: US 2026/0086989 A1
(43) Pub. Date: Mar. 26, 2026

(54) APPARATUS AND METHOD FOR DATA PREPARATION ANALYTICS, PREPROCESSING AND CONTROL IN A WIRELESS COMMUNICATIONS NETWORK

(71) Applicant: Lenovo (Singapore) Pte. Limited, Singapore (SG)

(72) Inventors: Konstantinos Samdanis, Munich (DE); Emmanouil Pateromichelakis, Viersen (DE); Dimitrios Karampatsis, Ruislip (GB)

(73) Assignee: Lenovo (Singapore) Pte. Limited, Singapore (SG)

(21) Appl. No.: 19/112,321

(22) PCT Filed: Nov. 10, 2022
(86) PCT No.: PCT/EP2022/081511

§ 371 Date: Mar. 17, 2025

(30) Foreign Application Priority Data
Oct. 3, 2022 (GR) 20220100811

(51) Int. Cl. G06F 16/215

(52) U.S. Cl. CPC G06F 16/215; G06F 11/1474

(57) ABSTRACT

There is provided a data preparation function in a wireless communication network, the data preparation function comprising: one or more processors arranged to: collect data from one or more data sources in the wireless communication network; analyse the collected data to derive one or more data characteristics and to identify whether the collected data face one or more quality issues or irregularities; and prepare the collected data based on the analysis, including performing one or more of the following: data recovery to recover data missing from the collected data; data cleaning of the collected data; formatting of the collected data; or separation of the collected data into different data sets for one or more training tasks.

### FIELD

The subject matter disclosed herein relates generally to the field of data preparation of analytics data in the 3GPP architecture. This document defines a data preparation function, a data preparation method, and a controller for the data preparation function.

### BACKGROUND

Network analytics and Artificial Intelligence (AI)/Machine learning (ML) is deployed in the 5G core network via the introduction of a Network Data Analytics Function (NWDAF). Various analytics types, that can be distinguished using different Analytics IDs, e.g., “UE Mobility”, “NF Load”, etc., may be supported. This is discussed in TS 23.288.

Each NWDAF may support one or more Analytics IDs and may have the role of implementing: (i) AI/ML inference, called NWDAF AnLF, or (ii) AI/ML training, called NWDAF MTLF, or (iii) both.

Currently, in the 3GPP architecture there is no consideration regarding the data preparation, which is the first step of analytics that significantly influences the analytics performance.

### SUMMARY

Disclosed herein are procedures for data preparation for analytics data in the 3GPP architecture. Also disclosed herein are a data preparation function arranged to perform said data preparation. Also disclosed herein is a controller for controlling operation of the data preparation function.

There is provided a data preparation function in a wireless communication network. The data preparation function comprises one or more processors arranged to: collect data from one or more data sources in the wireless communication network; analyse the collected data to derive one or more data characteristics and to identify whether the collected data face one or more quality issues or irregularities; and prepare the collected data based on the analysis, including performing one or more of the following: data recovery to recover data missing from the collected data; data cleaning of the collected data; formatting of the collected data; data labeling or separation of the collected data into different data sets for one or more inference and/or training tasks.

There is further provided a data preparation function controller for controlling the data preparation performed by the data preparation function.

There is further provided a data preparation method performed in a wireless communication network. The data preparation method comprises: collecting data from one or more data sources in the wireless communication network; analysing the collected data to derive one or more data characteristics and to identify whether the collected data face one or more quality issues or irregularities; and preparing the collected data based on the analysis, including performing one or more of the following: data recovery to recover data missing from the collected data; data cleaning of the collected data; formatting of the collected data; data labeling or separation of the collected data into different data sets for one or more inference and/or training tasks.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for data preparation and control will now be described, by way of example only, with reference to the accompanying drawings, in which:

FIG. 1 depicts a wireless communication system;

FIG. 2 depicts a user equipment apparatus;

FIG. 3 depicts a network node;

FIG. 4 is a schematic illustration of a network, and illustrates various types of NWDAF;

FIG. 5 is a schematic illustration showing the ORAN AI/ML General Procedures;

FIG. 6 is a schematic illustration of a wireless communication network;

FIG. 7 is a schematic illustration illustrating a sequence of the operations related to data preparation;

FIG. 8 is a process flow chart showing a method of data preparation for analytics data in the 3GPP architecture;

FIG. 9 is a process flow chart showing a further method of data preparation for analytics data in the 3GPP architecture;

FIG. 10 is a process flow chart showing a yet further method of data preparation for analytics data in the 3GPP architecture; and

FIG. 11 is a process flow chart showing a method of data preparation, as performed by an apparatus in the wireless communication system.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

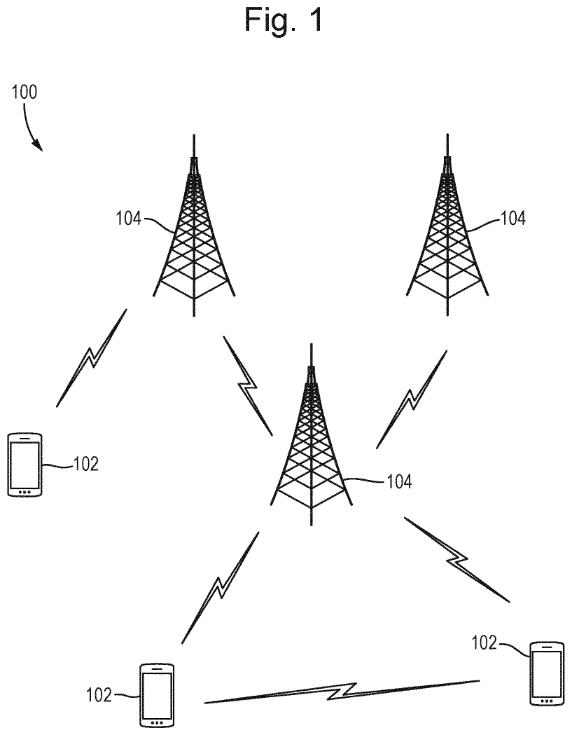

FIG. 1 depicts an embodiment of a wireless communication system 100 in which a data preparation method, a data preparation function, and a controller for the data preparation function may be implemented. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

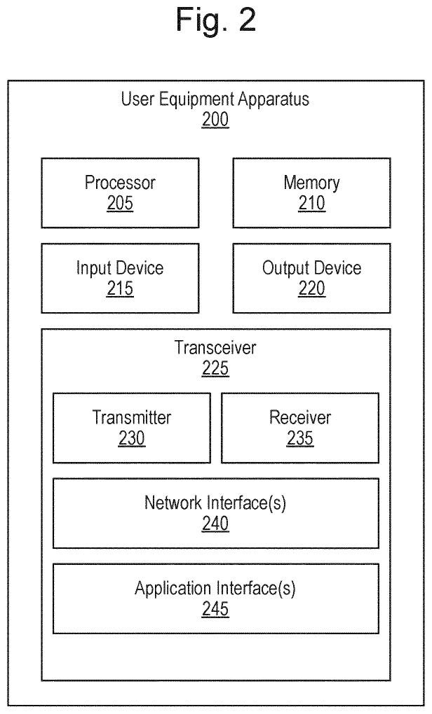

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be in accordance with or the same as the remote unit 102 of FIG. 1. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPL”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

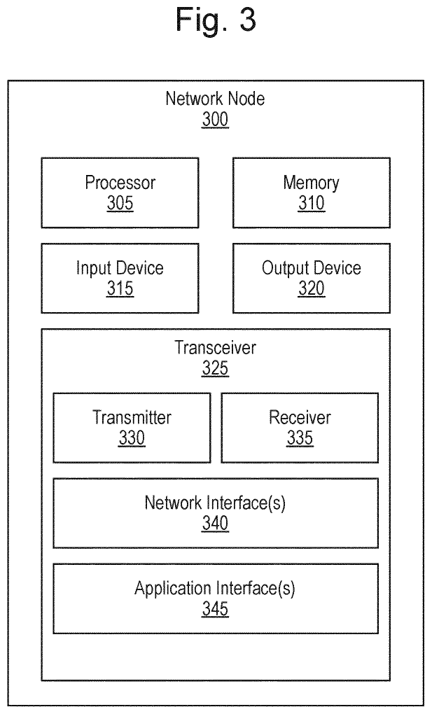

FIG. 3 depicts further details of the network node 300 that may be used for implementing the methods described herein. The network node 300 may be one implementation of an entity in the wireless communications network, e.g. in one or more of the wireless communications networks described herein, e.g. the wireless network 100 of FIG. 1. The network node 300 may be, for example, the UE apparatus 200 described above, or a Network Function (NH) or Application Function (AF), or another entity, of one or more of the wireless communications networks of embodiments described herein, e.g. the wireless network 100 of FIG. 1. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

The following information is useful in the understanding of the methods and apparatuses for data preparation for analytics data in the 3GPP architecture, which are described later below.

Currently, network analytics and AI/ML is deployed in the 5G core network via the NWDAF. Various analytics types may be supported. The various analytics types can be distinguished using different Analytics IDs, e.g., “UE Mobility”, “NF Load”, etc. This is discussed in TS 23.288. Each NWDAF may support one or more Analytics IDs and may have the role of: (i) AI/ML inference, called NWDAF AnLF; or (ii) AI/ML training, called NWDAF MTLF; or (iii) both.

NWDAF AnLF, or simply AnLF, and NWDAF MTLF, or simply MTLF, represent logical functions that can be deployed as standalone functions or in combination. AnLF that supports a specific Analytics ID inference using a AI/ML Model subscribes to a corresponding MTLF that is responsible for the training of the same AI/ML Model used for the respective Analytics ID.

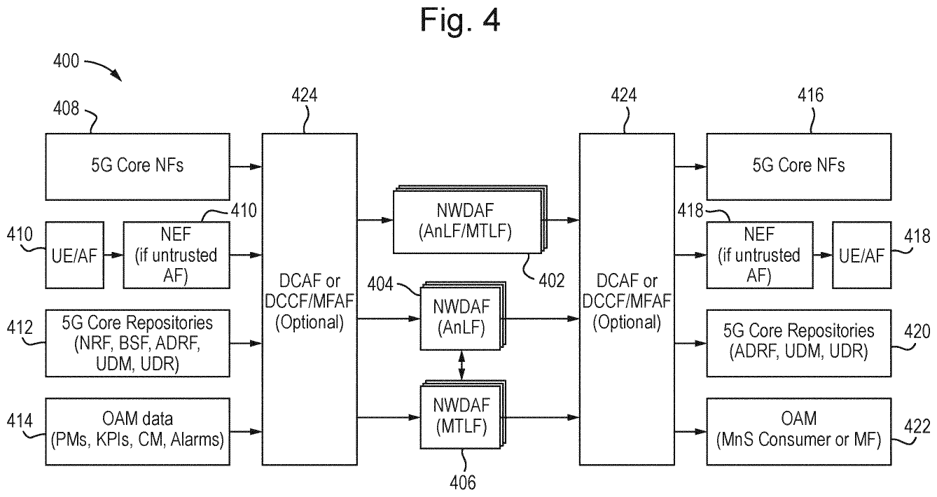

FIG. 4 is a schematic illustration of a network 400, and illustrates the various NWDAF “flavours” or types (specifically an NWDAF AnLF/MTLF 402, an NWDAF AnLF 404, and an NWDAF MTLF 406), and their respective input data and output result consumers. Specifically, an Analytics ID, contained in a NWDAF 402, 404, 406, relies on various sources of data input including data from 5G core NFs 408, AFs 410, 5G core repositories 412, e.g., Network Repository Function (NRF), UDM, etc., and OAM data 414, e.g., PMs/KPIs, CM data, alarms, etc. An Analytics ID contained in AnLF and may provide analytics output result towards 5G core NF 416, AF 418, 5G core repositories 420, e.g., UDM, UDR ADRF, or OAM MnS Consumer or MF 422.

MTLF and AnLF may exchange AI/ML models, e.g., via the means of serialization, containerization, etc., including related model information. Optionally, a DCCF and MFAF 424 may be involved to distribute and collect repeated data towards or from various data sources.

Currently, in the 3GPP architecture there is no consideration regarding the data preparation, which is the first step of analytics that significantly influences the analytics performance. Data preparation may be considered to be an essential step in AI/ML model lifecycle and is the process of preparing raw data so that it is suitable for analytics. When employing AI/ML-enabled analytics in 3GPP, data preparation tends to be particularly important, since typically a variety of data is collected from different types of sources, which may include but are not limited to UEs, network functions, management entities, and application entities. Such data may be used for AI/ML model training and/or inference, and it is preferred that the quality of the data is optimal.

Data preparation is responsible for (i) understanding the characteristics of data, i.e., collecting information about the data, e.g., type of data, range, etc., (ii) determining if the data suffers from quality issues, e.g., errors or missing values, and dealing with them, and (iii) formatting and labelling data, preparing also the data set(s) for training purposes. Data preparation can pre-process raw data from the UE, network, and application sources into a data format that can feed both AI/ML model training and inference phases. Raw data sources may include the following types of data:
Numeric: values of real data that allow arithmetic operations
Interval: Values that allow ordering and subtraction, e.g., time windows.
Ordinal: Values that allow ordering but not arithmetic operations, e.g., Quality of Experience (QoS)—low, medium, high.
Boolean: Binary values, e.g., 0 and 1.
Categorical: Finite set of values that cannot be ordered or perform athematic operations, e.g., UE, MICO.
Textual: Free-form text data, e.g., name or identifier.

Data preparation is already considered in the ORAN architecture (O-RAN.WG2.AIML-v01.03), but it is considered as implementation specific component, mentioning only some of its functionalities that include data inspection and data cleaning.

According to ORAN, data preparation depends on the use case (i.e., analytics type) and AI/ML model architecture employed, and has an impact on the model performance.

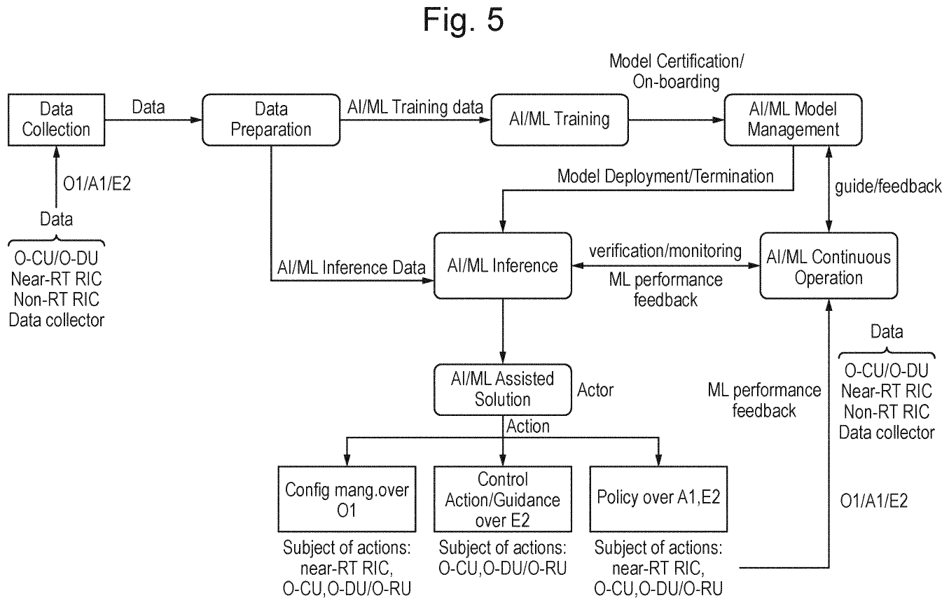

FIG. 5 is a schematic illustration showing the ORAN AI/ML General Procedures, as specified in O-RAN.WG2.AIML-v01.03.

However, data preparation may require guidance on how to deal with low data quality issues. Such guidance may depend on, for example, the: i) analysis of the data characteristics, ii) the type of the AI/ML Model that uses the data, and/or iii) the availability of external tools or data sources. Also, the guidance may rely on input provided by 5G NE's, AFs including 3rd parties, and other network tools.

Implementation specific solutions may rely on pre-configured or “closed” mechanisms to deal with data preparation, or can be vendor specific. However, pre-configuration, “closed” or vendor specific solutions may fail to deal with unknown problems and may introduce overhead for preparing data that can be consumed only by specific NWDAFs, which cannot be shared with other vendors. Data preparation may also span over the two flavors of NWDAF, i.e., the MTLF for training and the AnLF for inference respectively, which can be deployed by different vendors. Thus, coordination of the configuration of data preparation may be needed and, if no dedicated functionality exists, such logic may need to be present at both MTLF and AnLF. This tends to introduce a higher overhead. In addition, implementation specific solutions tend to limit the interaction with other tools, e.g., a digital twin or a sandbox, or the interaction with 5G NFs, AF from 3rd parties, and the OAM (which can be offered by a different administrative player). In summary, poor and inaccurate data preparation can lower the performance of the AI/ML, for example by introducing model drift, while a data preparation with open control can be tailored based on the type of data, on the use of data for a given analytics event, type of the consumer, and/or data source profile.

The notion of formatting and/or processing in the current 3GPP architecture is introduced via the DCCF/MFAF, which may be provided in requests by data consumers as described in clause 5A.4 in TS 23.288. When using the messaging framework, the DCCF sends the formatting and/or processing instructions to the messaging framework, so the MFAF may format and/or process the data before sending notifications to the data consumers or other notification endpoints. When using data delivery via the DCCF, the DCCF performs formatting and/or processing before sending notifications.

Formatting determines when a notification is sent to the consumer, e.g., considering time of an event trigger. This process typically has nothing to do with converting the data into a shape or format useful for the AI/ML model.

On the other hand, the processing of instructions allows summarizing of notifications to reduce the volume of data reported to the data consumer. The processing results in the summarizing of information from multiple notifications into a common report. Processing of data for inclusion in each notification sent to consumers occurs over a processing interval specified in the processing instructions. Processing instructions are provided per Event ID and are applied to multiple notifications that result from the same subscription and for the same Event ID. Processing instructions, in addition to the processing interval, may specify the parameter names, parameter values, and the attributes to be determined and reported to the consumer. The processed notifications may comprise the Event name, processing interval, and a list of various statistical information.

The data processing/preparation methods and apparatuses described herein can take advantage of the current state of the art in preparing the data analysis for identifying data irregularities.

For performing data simplification, by aggregating data from different sources or by introducing a sampling rate to reduce data set if that is too big, e.g., random sampling to reduce the data, i.e., by a certain percentage, the data preparation methods and apparatuses described herein can take advantage of the existing procedures related to contents of analytics exposure as documented in clause 6.1.3 TS 23.288.

The notion of data preparation is also introduced in ITU-T Y.3172 (06/2019) as a pre-processor node or logical entity that is responsible for cleaning data, aggregating data, or performing any other pre-processing needed for the data to be in a suitable form so that the ML model can consume it. ITU-T Y.3172 discusses the ML-pipeline control, i.e., how to combine the pre-processor with other ML related entities.

However, introducing a data preparation entity including the respective control with standardized interfaces to control the date preparation, i.e., allowing access and interaction with other NFs, AFs, OAM, tools, and 3rd parties, is still an open issue. Such data preparation and control can provide data sharing among various NWDAFs and can enhance the solution options when data preparation is facing data quality issues.

This disclosure deals with the operations of data preparation that involve the pre-processing of raw data into a form that is ready to be used by the AI/ML model. Data preparation deals with two main types of data: continuous (i.e., data values as a function of time) and categorical (data that belongs to different categories or levels/states). It is the initial step in the network analytics and can include several different tasks such as loading of data from selected data sources, data analysis, data cleaning, data processing or modification and data augmentation. These tasks fall into the following main categories:
i) data collection and analysis to identify irregularities;
ii) data recovery and cleaning considering (a) systematic errors involving large data records from different data sources and/or (b) individual data errors due to random or processing errors;
iii) data formatting; and
iv) data labelling and separation into sets for accommodating different training tasks.

For example, the inputs from the data sources for the Analytics ID=“Load level information” related to the Slice load level related network data analytics in clause 6.3 TS 23.288 are summarized in Table 6.3.2A-1 and Table 6.3.2A-2, which are reproduced below. Here, the OAM provides load of NIs associated to a network slice instance. Table 6.3.2A-1 may have missing values for a certain time window, which can be recovered by requesting again the same data from an alternative data source, e.g., via NRF.

In another example, there may be missing data with certain expected time stamps for, e.g., UE registers/de-registers to a Network Slice/Network Slice instance, over a certain time window. If this data is absent, it may impact the performance of the Analytics ID even though other input data is present. In case missing data is observed for various input data sources, e.g., for both Number of UEs served by the AMF and Load of NFs associated to Network Slice instance, with different time stamps or the collected input data contains outliers (contain values beyond what is expected), this may again negatively impact the performance of the Analytics ID.

TABLE 6.3.2A-1
OAM Input data for slice load analytics (TS 23.288)

| Information | Source | Description |
|---|---|---|
| UE registered in a Network | OAM | Mean number of UEs registered in a NW slice or NW slice |
| Slice/Network Slice instance | | instance as defined in TS 28.552 [8]. (NOTE 1). |
| PDU Session established on | OAM | Mean number of established PDU Sessions in a NW slice or NW |
| a Network Slice/Network | | slice instance as defined in TS 28.552 [8]. (NOTE 1). |
| Slice instance | | |
| Load of NFs associated to | OAM | Resource utilization information of a Network Slice instance |
| Network Slice instance | | obtained from its constituent NF instances. NF instance load |
| | | input data collection is described in clause 6.5, Table 6.5.2-1. |

NOTE 1:
5GC performance measurements can be provided per S-NSSAI by OAM as defined in TS 28.552 [8]. Any 5GC performance measurements per NSI ID required further coordination with SA WG5.

TABLE 6.3.2A-2
5GC NF Input data for slice load analytics (TS 23.288)

| Information | Source | Description |
|---|---|---|
| Timestamps | 5GC NF | A time stamp associated with the collected information. |
| UE registers/de-registers to a | AMF(s) | AMF reports that a UE registered or deregistered to a S-NSSAI |
| Network Slice/Network Slice | | or to a S-NSSAI and NSI ID. |
| instance | | |
| Number of UEs served by the | AMF(s) | AMF reports the total number of UEs served by the AMF per S- |
| AMF | | NSSAI or per S-NSSAI and NSI ID. (NOTE 1) |
| PDU Session | SMF(s) | SMF reports that a PDU Session is established or released per |
| established/released on a | | S-NSSAI or per S-NSSAI and NSI ID. |
| Network Slice | | |
| Current number of UEs | NSACF | NSACF reports the number of UE registered at the S-NSSAI. |
| registered in a NW slice | | |
| Current number of PDU | NSACF | NSACF reports the number of PDU Sessions established at the |
| Sessions established in a | | S-NSSAI. |
| NW slice | | |
| Load of NFs associated to | NRF | Resource utilization information of a Network Slice instance |
| Network Slice instance | | obtained from its constituent NF instances. NF instance load |
| | | input data collection is described in clause 6.5, Table 6.5.2-1. |

NOTE 1:
AMF reports the total number of registered UE in the AMF at each associated time stamp.
NOTE 2:
SMF reports multiple PDU Sessions when establishment or release happened at the same time, indicated by the time stamp.
NOTE 3:
Based on the internal logic, the NWDAF determines the source for the data collection.

This disclosure proposes a new network function that is responsible for data preparation in the 3GPP Service Based Architecture (SBA), referred to as data preparation function (DP). The DP can be a new NF, or a logical NF that can be a part an existing NF. For example, the DP may be part of the NWDAF, and may be configured to prepare the data locally either in the training mode, i.e., MTLF, or inference mode, i.e., AnLF. Alternatively, the DP may, for example, be a part of the DCCF/MFAF or DCAF to assist the collection of data with data preparation services enhancing the current formatting and processing, such as documented in clause 5A.4 in TS 23.288. The DP functionality may rely on a DP Control (DPC) that allows a dedicated 5G core NF, e.g. a DCP NF, or a 3rd party AF, or the OAM to control the data quality issues by the means of (i) installing an algorithm, model, function, etc., (ii) meta language that assist to describe an algorithm, model, function, etc., (iii) selecting a method out of a predefined list, or (iv) pointing to an assisting tool, e.g. digital twin.

The data quality issues can be regulated for a particular Analytics ID, AI/ML model, and/or for a specific, e.g., application (for QoE) or geographical area or UE(s), for example by instructing the adoption of different algorithms/models, mechanisms, and tools to deal with data preparation, e.g., cleaning data, recovering missing data, formatting, labeling and dividing data into different groups for performing AI/ML model inference and/or training.

The data preparation allows a flexible way to share and control the preparation of data by 5G core NFs, OAM, AFs (which can also belong to 3rd parties) and using non 3GPP tools (e.g., digital twin to get missing data). Such apparatus defines: i) the DP as a NF (or logical NF), ii) the DPC as a NF (or logical NF), iii) the interface between that allows the monitoring and quality control by providing instruction on how to handle data irregularities in data preparation.

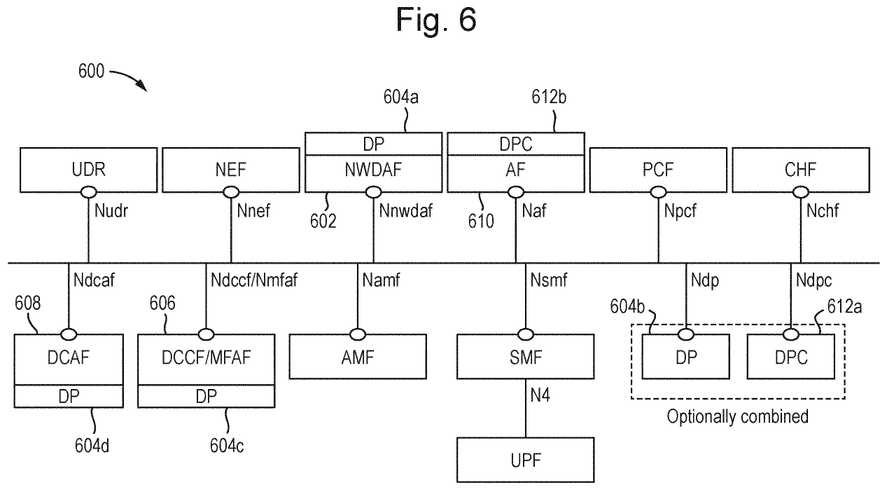

FIG. 6 is a schematic illustration of a wireless communication network 600, and illustrates ways in which the DP and DPC may be adopted into the 3GPP SBA.

Typically, NWDAF MTLF or AnLF 602 is the consumer of the DP result, i.e., the formatted data, which is ready for the AI/ML model to use for training or inference. Different implementation scenarios can be realized depending on where and how the DP NF is deployed, i.e., whether DP is deployed a part of the NWDAF 602 (as illustrated by the DP′ indicated in FIG. 6 by the reference numeral 604a), or as a standalone NF in SBA (as illustrated by the DP indicated in FIG. 6 by the reference numeral 604b), or as an enhancement of a data collection entity, e.g., DCCF/MFAF 606 or DCAF 608 (as illustrated by the DPs indicated in FIG. 6 by the reference numerals 604c and 604d, respectively).

The controller of the DP, i.e., the DPC, can be a part of or a standalone NF within the network operator premises, or can optionally be combined with the DP (as illustrated by the DPC indicated in FIG. 6 by the reference numeral 612a). The DPC 612a in this case can be configured by the OAM via conventional Configuration Management (CM) provision mechanisms as documented in TS 28.510, TS 28.511, TS 28.512, TS 28.513. The OAM can configure a library of algorithms, or models or mechanisms that shall be used for certain scenarios, such as described in more detail later below. Allowing the OAM to perform the CM provisioning of the DP, a dynamic configuration according to the network operator needs tends to be achieved. This does not necessarily mean that a configuration may change frequently but rather that the operator has the capability to introduce and change it according to its needs.

Alternatively, the DPC can be a logical NF outside the network operator premises, i.e., a logical DPC within an AF 610 (as illustrated by the DPC indicated in FIG. 6 by the reference numeral 612b). This may allow a third party to control the DP process. Typically, the configuration of the DP can be performed when a new Analytics ID is selected by a consumer or an AF for providing a new request or upon a particular event trigger, e.g., the network conditions change significantly or a change from peak to off-peak due to a load increase/decrease. In particular, the DPC AF 612b can either select mechanisms assuming that different options are already installed or introduce a library of mechanisms in the DP to handle data preparation.

The implementation scenarios for realizing the DP NF and the DPC NF, may include but are not limited to the following ones:
The NWDAF (MTLF/AnLF) is a consumer of data preparation and issues a request or subscription to:
   the DP NF for preparing the analytics data; the DP NF is controlled by an AF that holds the logical DCP functionality (an interaction, which is carried out via a Network Exposure Function (NEF) if the AF is untrusted).
   the DP NF for preparing the analytics data; the DP NF controlled by DPC NF, which can be configured by the OAM to control the data preparation process.
   the DCAF that contains a logical DP functionality; the DCAF can then be controlled by an AF that hold the logical DCP functionality (an interaction, which is carried out via NEF if the AF is untrusted).
   the DCCF/MFAF that contains a logical DP functionality; the DCCF/MFAF can then be controlled by a DCP NF, which can be configured by the OAM.
NWDAF (MTLF/AnLF) contains a logical DP NF and is a consumer of the data preparation control issuing a request or subscription to:
   the DCP NF, which can be configured by the OAM.
   an AF that holds the logical DCP functionality; an interaction, which is carried out via NEF if the AF is untrusted.

The DP NF or logical DP NF includes at least one of the following operations:

1. An operation to select data set or records from certain data sources or type(s) of data source (allowing a good fix of data from different sources for completeness) as indicated in the received Analytics ID or Analytics type, i.e., related to the analytics job. The selection of data sources or records may also be influenced by the expected waiting time indicated by the consumer.
2. An operation to analyse the data for information extraction regarding the:
Central tendency and variation, i.e., what values shall be expected mostly and what would be the variation, e.g., extracting the data mean, variation, minimum, maximum, and other statistical properties included the distribution of data.
Relative effect among variables or features, e.g., how the values of one variable or feature changes in relation with another.
Amount of data adequate for the requested task (i.e., Analytics ID).
   3. A data exploration operation to identify if the collected data faces quality issues including:
Anomalies due to errors in data source, i.e., faults or security incidents, or data transfer errors.
Missing values: a) in terms of the percentage per feature (a feature may be an individual measurable property or characteristic of the data that feed an AI/ML algorithm, e.g., UE type, mobility type, etc.) or with respect to a specific value range, or other data conditions, and b) in terms of reasoning, e.g., integration errors or processing errors if data preparation needs to generate new values for usage of the AI/ML algorithm or indicate data unavailability from data sources.
Irregular cardinality, where there is a need to check for: a) feature errors (e.g., different data sources may indicate the same feature using different names or IDs), b) impractical features, e.g., with value of 1 (i.e., a feature that is identified by the developer but has no practical meaning for the AI/ML algorithm), and c) data that concentrate only on a particular range.
Outliers that characterize values far beyond the expected range considering values that are: a) valid, i.e., correct values, but very different from what expected, or b) invalid, i.e., incorrect noise values that are inserted due to an error.
   4. Data processing carries out the instructions or configuration provided by the DPC function related to:
Executing a method to augment, replace, or account for missing data, for example, considering the: a) indicated range, b) percentage and volume of missing data, c) a method for augmenting, replacing, or accounting for missing data, etc.
Executing a policy to perform data cleaning to get rid of outliers and random errors, for example, by: i) removing data or ii) introduce a weight to reduce their impact of certain data.
Optionally, indicating an expected performance impact on the AI/ML model in case input data from a particular source is still missing, i.e., even after interacting with DPC, due to incapability of the selected method to retrieve the data.
Simplifying indicated data.
   5. Data formatting carries out the instructions given by the DPC function to convert data into the appropriate shape or format needed by the AI/ML model.
   6. Prepare data sets for inference, training, validation, and testing according to the instructions given by the DPC function.

Points 1-3 above relate to data analysis, while points 4-6 above relate to data processing.

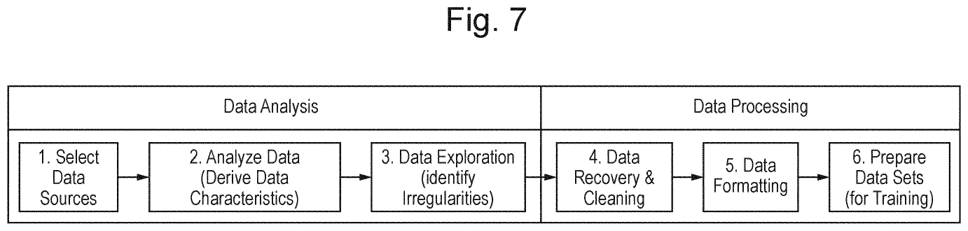

FIG. 7 is a schematic illustration illustrating a sequence of the operations related to the data preparation, corresponding to point 1-6 described in more detail above.

Although FIG. 7 shows a certain sequence of steps, this sequence can be also differently executed, e.g., steps 4 and 5 can be reversed allowing the data processing first before the data recovery and cleaning.

With respect to the existing formatting and processing described in clause 5A.4 in TS 23.288, this disclosure may introduce new Events such as those outlined below in the following Table:

TABLE 5A.4-1
Examples of Event Parameter Names, Parameter values (including
those presented in TS 23.288 and new Events)

| | Event parameter | Parameter | |
|---|---|---|---|
| Event | name | values | Attributes |
| Location Report | TAI | TAI-7 | Average and variance of the time interval |
| | | | between TA boundary crossings. |
| | | | Number of TA boundary crossing. |
| Number of UEs in a | Region | AMF-3 | Average and variance of the number of UEs in the |
| Region | | | Region. |
| UE Reachability | CM State | Connected | Average and variance of time between CM |
| (status change) | | | connected state transitions. |
| | | | Average and variance of the time spent in CM |
| | | | connected state. |
| | | | Number of transitions to CM connected state. |
| PDU Session | DNN | Internet | Average and variance of time between PDU |
| Establishment | | | Session establishments to the Internet DN. |
| | | | Average and variance of the duration of PDU |
| | | | Sessions established to the Internet DN. |
| | | | Number of PDU Session establishments to the |
| | | | Internet DN. |
| PDU Session | PDU Session Type | Ethernet | Average and variance of time between Ethernet |
| Establishment | | | PDU Session establishments. |
| | | | Average and variance of the duration of Ethernet |
| | | | PDU Sessions. |
| | | | Number of Ethernet PDU Session establishments. |
| Data Analysis Report | Analytics ID | Data Sources | Average and variance of the input from each data |
| | | per | source. |
| | | Analytics ID | Relative variance of input among different data |
| | | | sources. |
| | | | Amount of data per data source. |
| Data Exploration | Analytics ID | Data Sources | Anomalies due to errors in the input of each data |
| Report | | per | source |
| | | Analytics ID | Percentage of missing values and reasoning. |
| | | | Irregular cardinality type. |
| | | | Outlier values far beyond the expected range. |

The DPC NF or logical DPC NF that is responsible for controlling the DP process can include at least one of the following operations:
Data recovery and cleaning to suggest the type of method to re-create data or delete data, including operations to:
   Determine the method to augment missing data considering the percentage and reasoning of missing data using at least one of the following methods:
      re-collecting data from the same or different data sources,
      deriving/producing new data via specific simulation tools (e.g., digital twin that can simulate a network environment to collect the missing data from the corresponding sources),
      null/mode/median value replacement considering neighbor values,
      interpolation—determining a value from the existing values, i.e., by inserting or interjecting an intermediate value between two other values,
      extrapolation—determining a value from values that fall outside a particular data set based on, e.g., curve's trajectory or the nature of the sequence of known values,
      forward filling/backward filling using the first or last value to fill the missing ones,
      multiple imputation considering the uncertainty of missing data by creating several different plausible imputed data sets and appropriately combining results obtained from each of them,
      using a predictive model (i.e., model-based imputation) to estimate missing values, e.g., regression, K-nearest neighbors, etc.
   Suggest one or more policies to the DP to perform data cleaning to get rid of outliers and random errors e.g., by introducing minimum and/or maximum thresholds, or by comparing the distance between mean, and 1st quartile and/or 3rd quartile and/or via other statistical means to:
      remove/delete data values characterized as outliers;
      introduce one or more weights to reduce the impact of outliers on the AI/ML algorithm.
   Suggest simplifying data e.g., by deleting data related to certain AI/ML features, i.e., if the collected data is very little, e.g., if 60% of data is missing, or simplify redundant features.
Data formatting including the selection of data sources, converting data into the appropriate shape or format, and suggesting the DP to use at least one of the following:
   Sort data, i.e., pre-sort data into a particular order.
   Aggregation to merge data from selected sources, optionally using a different weight for each data source or a different sample rate per data source, to control the impact of different sources.
   Dimensionality reduction to combine or relate different types of data.
   Normalization to change a continuous data to fall into a particular range maintaining the relative distance between the values.
   Binning to convert one category of data to another, e.g., convert continuous data into categorical or discretize data or convert categorical text data to categorical number data.
   Sampling to reduce data set if that is too big, e.g., random sampling or sampling using a specific function.
Dividing/splitting or preparing non-overlapping data sets, including labelling into inference data, training data, validation data, and testing data. This may include formulating sets considering volume per usage (i.e., typically validation and testing include 10-20% of the available data) and creating a strategy into the type of data inserted in each set, e.g., more recent data to be used for validation/testing. This step may also include the labelling of data, which may involve characterizing data for use in the AI/ML model.

It shall be appreciated by those skilled in the art that the methods suggested in relation with augmenting, cleaning, formatting, and diving data as a part of the DPC are just examples and that other methods that perform similar processes can be adopted instead of or in addition to those mentioned above.

The DP NF can register in the NRF indicating its capabilities of e.g., geographical area, load, capacity, etc. This may be performed similarly to how the NWDAF would register itself. The discovery procedure could follow the procedure defined in TS 23.501. If the DP is a logical NF co-located with another NH, then the registration of such an NF may include the DP as a capability of that NF. The DPC can be registered in the NRF and be discovered in the same way as the DP or, alternatively, if the DPC resides in a 3rd party AF, an application ID or AF ID can be used to point towards the appropriate AF DPC.

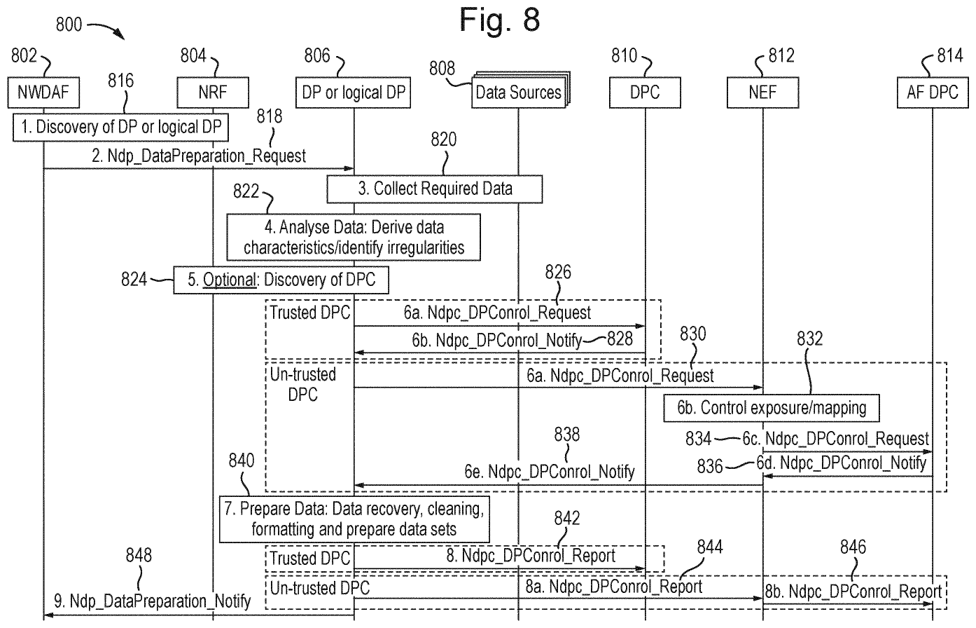

FIG. 8 is a process flow chart showing an embodiment of a method 800 of data preparation for analytics data in the 3GPP architecture.

The method 800 may involve an NWDAF 802, an NRF 804, a DP (which may be a standalone NF or a logical NF) 806, data sources 808, a DPC 810, an NEF 812, and an AF DPC 814.

The NWDAF 802, the NRF 804, the DP 806, one or more of the data sources 808, the DPC 810, the NEF 812, and/or the AF DPC 814 may be the same as or in accordance with any network entity, function, or node described herein. For example, the NWDAF 802, the NRF 804, the DP 806, one or more of the data sources 808, the DPC 810, the NEF 812, and/or the AF DPC 814 may be the same as the network node 300 shown in FIG. 3 and described in more detail earlier above.

The NWDAF 802, the NRF 804, the DP 806, one or more of the data sources 808, the DPC 810, the NEF 812, and/or the AF DPC 814 may be the same as or in accordance with any of the UEs described herein. For example, one or more of the data sources may be the same as the UE 200 shown in FIG. 2 and described in more detail earlier above.

In this embodiment, it may be the case that the NWDAF MTLF/AnLF 802 has received a request to retrain a specific Analytics ID and AI/ML model. The DP 806 and the corresponding control, i.e., DPC 810, may be separate NFs or logical NFs. The method 800 comprises the following steps:

At step 816, the NWDAF MTLF/AnLF 802 performs a discovery process, such as that defined in TS 23.501, to identify the corresponding DP 806 that may reside either in the DCCF/MFAF or DCAF.

At step 818, once the appropriate DP 806 is selected, the NWDAF 802 then issues a data preparation request (Ndp_DataPreparation_Request) that may include at least one of the following attributes:
Analytics ID and/or AI/ML Model that will consume the prepared data.
Time scheduling related to the time window that the prepared data is expected.
Identifier of data sources or type of data sources if a specific identifier is not known.
Expected waiting time bound for preparing the data.
Statistical properties for the prepared data, e.g., range, volume, distribution, etc.
Subscription Correlation ID in the case of modification of the analytics request.
Expected processing of data as input to the AI/ML model, i.e., sorted data format, normalization, sampling rate to reduce the data, etc.
Preferred level of accuracy to deal with missing values or outliers.
Indication of the format of the prepared data, e.g., into a file with specific characteristics.

At step 820, the DP 806 collects the data from the respective data sources 808 based on the input received in the Ndp_DataPreparation_Request.

At step 822, the DP 806 then performs the analysis of data for information extraction to derive the data characteristics and explore the data to identify if the collected data faces quality issues or irregularities.

At step 824, the DP 806 optionally discovers the DPC NF 810 if that resides in the network operator premises. Alternatively, the DP 806 identifies the DPC 810 from the data sources received in the Ndp_DataPreparation_Request, or from an explicit identifier such as, e.g., an application ID or AF ID.

After step 824, the DP 806 requests and receives control information related to the data preparation from the respective DPC 810.

Two different cases are now considered depending on where the DPC 810 resides. Specifically, if the DPC 810 resides on a trusted entity, the method proceeds with steps 826 and 828; after step 828 the method continues to step 840. On the other hand, if the DPC 810 resides on an untrusted entity, the method proceeds with step 830 to 838; after step 836 the method continues to step 840.

The DPC 810 may be considered a trusted DPC when it resides in the network operator premises. On the other hand, the DPC 810 may be considered an untrusted DPC when it resides outside the network operator premises.

Considering first the case where the DPC 810 resides on a trusted entity, at step 826, the DP 806 issues a request, Ndpc_DPControl_Request, to the DPC 810. This request may contain one or more of the following:
A description of data characteristics using standard statistics, e.g., for continuous data the min, mean, variation, 1st quartile, etc. or for categorical the frequency of a state.
Information relating to missing data values, i.e., the ranges, volume (number of samples), etc.
Information relating to outliers, e.g., percentage, distance from threshold, etc.
An indication of a data simplification method to be implemented, e.g., sort data, normalizing, or deleting data, based on the expected processing of the NWDAF 802 and the data analysis results.
Missing data labels to characterize the data.

At step 828, the DPC 810 sends a response, Ndpc_DPControl_Notify, to the DP 806. This response may contain or indicate one or more of the following:
A strategy for dealing with missing data and other data irregularities. This may include or indicate:
   a type of problem, i.e., missing data, outliers, etc.
   a method to deal missing values, e.g., use digital twin tool, or provision of the predictive model/method (if the percentage and range of missing values are known).
   a method to deal outliers, e.g., provision of min-max values or weight values.
   a level of accuracy to deal with missing values or outliers.
   the data processing method,
   a data processing type, i.e., sorting, aggregating, normalization, binning, sampling.
   a description of the data processing, i.e., format of expected sorting, aggregation type, normalization range, binning methods, sampling method.
   labelling for the data (e.g., by provide labelling examples) or a labelling method.

After step 828 the method continues to step 840.

Considering now the case where the DPC 810 resides on an untrusted entity, at step 830, the DP 806 issues a request, Ndpc_DPControl_Request, towards the DPC 810. This request may contain the same attributes as described in the trusted case (see the description of step 826 above).

At step 832, the NEF 804 controls the exposure of the Ndpc_DPControl_Request. Specially, in this embodiment, the NEF 804 removes network specific information from the Ndpc_DPControl_Request. Also, the NEF 804, when receiving the Ndpc_DPControl_Notify message, performs a mapping towards the appropriate DP 806.

At step 834, the NEF 804 forwards the Ndpc_DPControl_Request that contains now abstracted data to the corresponding AF DPC 814.

At step 836, the AF DPC 814 responds to NEF 804 with a Ndpc_DPControl_Notify message, which contains the same information and attributes as described in the trusted case (see the description of step 828 above).

At step 838, the NEF 804 performs the mapping and forwards the Ndpc_DPControl_Notify to the corresponding DP 806.

After step 838 the method continues to step 840.

At step 840, the DP 806 prepares the data related to the NWDAF 802 Ndp_DataPreparation_Request based on the input from the DPC 810. This may include performing data recovery, cleaning, formatting and/or preparing data sets for training.

The DP 806 prepares a data quality report to share with the DPC 810, informing the DPC 810 on the result of its suggestions. In this embodiment, the data quality report is disseminated differently depending on whether the DPC 810 is trusted or un-trusted. Specifically, if the DPC 810 resides on a trusted entity, the method proceeds with step 842; after step 842 the method continues to step 848. On the other hand, if the DPC 810 resides on an untrusted entity, the method proceeds with step 844 and step 846; after step 846 the method continues to step 848.

Considering first the case where the DPC 810 resides on a trusted entity, at step 842, the DP 806 issues a Ndpc_DPControl_Report towards the DPC 810. This report may contain one or more of the following:
Information relating to missing data values, which may include i) the ranges, volume (number of samples), ii) the action or combination of actions taken to enhance existing data or mitigate against missing data, e.g., a) re-collection of data, or b) derivation of data e.g. via digital twin, and/or c) use of a predictive model/method, iii) a confidence degree for estimated missing data, and/or iv) a percentage of data fixed and/or still missing.
Information relating to outliers, such as i) a policy used to deal with outliers, e.g., deletion of outliers or the weights used to manipulate data, and ii) a percentage of outlier data fixed or that needs further action.
Information relating to data simplification, such i) methods used, e.g., deleting data or redundant features, ii) impact on the result, e.g., on desired data volume, confidence, etc.
Information relating to data processing and/or formatting activity, such as an indication of e.g., a) aggregation including data sources, b) normalization, c) binning including identity of original data type, and/or d) sampling including the percentage of data reduction.
Information relating to the accuracy of the labelling of data.
A time stamp of data preparation generation.

After step 842 the method continues to step 848.

Considering now the case where the DPC 810 resides on an untrusted entity, at step 844, the DP 806 issues a Ndpc_DPControl_Report towards the NEF 812. This report contains the same attributes as described in the trusted case (see the description of step 842 above).

At step 846, the NEF 812 exposes the data performing an abstraction to remove network operator specific information and forwards the Ndpc_DPControl_Report towards the respective AF DPC 814.

After step 846 the method continues to step 848.

At step 848, the DP 806 prepares the formatted data, and send the prepared data to the NWDAF 802 (e.g., the MTLF). The prepared data may be provided in the Ndpc_DataPreparation_Notify message.

Thus, a first embodiment of a method 800 of data preparation for analytics data in the 3GPP architecture is provided.

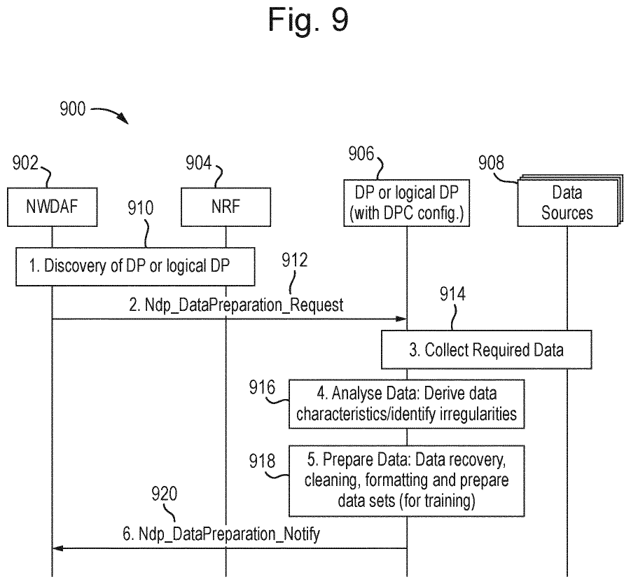

FIG. 9 is a process flow chart showing a second embodiment of a method 900 of data preparation for analytics data in the 3GPP architecture.

The method 900 may involve an NWDAF 902, an NRF 904, a DP (which may be a standalone NF or a logical NF) 906, and data sources 908.

The NWDAF 902, the NRF 904, the DP 906, and/or one or more of the data sources 908 may be the same as or in accordance with any network entity, function, or node described herein. For example, the NWDAF 902, the NRF 904, the DP 906, and/or one or more of the data sources 908 may be the same as the network node 300 shown in FIG. 3 and described in more detail earlier above.

The NWDAF 902, the NRF 904, the DP (with DPC configured therein) 906, and/or one or more of the data sources 808 may be the same as or in accordance with any of the UEs described herein. For example, one or more of the data sources 908 may be the same as the UE 200 shown in FIG. 2 and described in more detail earlier above.

In this embodiment, it may be the case that the NWDAF MTLF/AnLF 902 has received a request to retrain a specific Analytics ID and AI/ML model. The DP 906 and the corresponding control, i.e., DPC, are co-located. The method 900 comprises the following steps.

At step 910, the NWDAF MTLF/AnLF 902 performs a discovery process to identify the corresponding DP 906. This may be performed in the same way as at step 816 of the method 800, as described earlier above with respect to FIG. 8.

At step 912, the NWDAF 902 issues a data preparation request, Ndp_DataPreparation_Request. This may be performed in the same way as at step 818 of the method 800, as described earlier above with respect to FIG. 8.

At step 914, the DP 906 collects the data from the respective data sources 908. This may be performed in the same way as at step 820 of the method 800, as described earlier above with respect to FIG. 8.

At step 916 the DP 906 performs the analysis of data. This may be performed in the same way as at step 822 of the method 800, as described earlier above with respect to FIG. 8.

At step 918, the DP 906 then prepares the data related to the NWDAF Ndp_DataPreparation_Request. This may comprise performing data recovery, cleaning, formatting, and/or preparing data sets for training.

At step 920, the DP 906 then prepares the formatted data, and send the prepared data towards the NWDAF 902 (e.g., the MTLF). The prepared data may be provided in a Ndpc_DataPreparation_Notify message.

In addition, the DP 906 may provide a DPC report in the same way as at step 842 of the method 800, as described earlier above with respect to FIG. 8.

Thus, a second embodiment of a method 900 of data preparation for analytics data in the 3GPP architecture is provided.

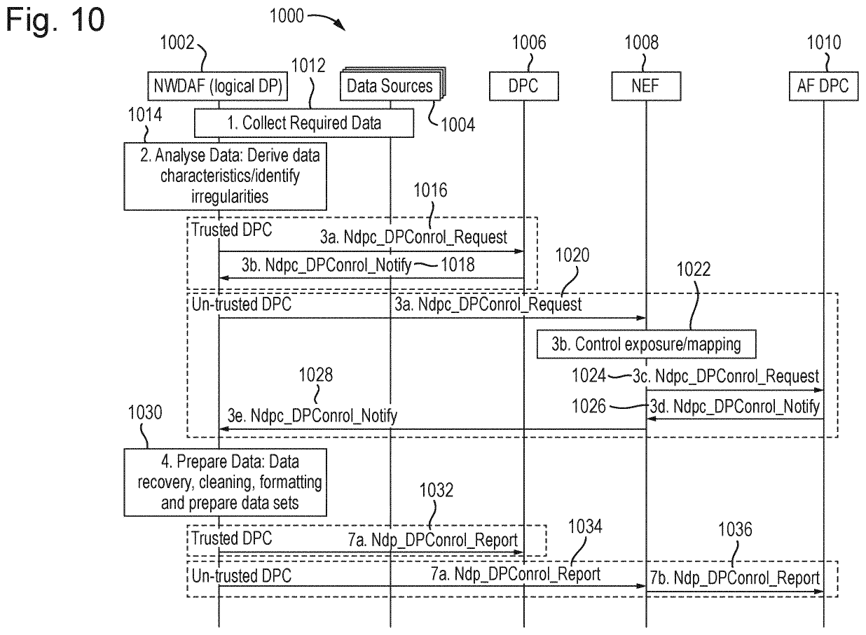

FIG. 10 is a process flow chart showing a third embodiment of a method 1000 of data preparation for analytics data in the 3GPP architecture.

The method 1000 may involve an NWDAF (in which a logical DP resides) 1002, data sources 1004, a DPC 1006, an NEF 1008, and an AF DPC 1010.

The NWDAF 1002, one or more of the data sources 1004, the DPC 1006, the NEF 1008, and/or the AF DPC 1010 may be the same as or in accordance with any network entity, function, or node described herein. For example, NWDAF 1002, one or more of the data sources 1004, the DPC 1006, the NEF 1008, and/or the AF DPC 1010 may be the same as the network node 300 shown in FIG. 3 and described in more detail earlier above.

The NWDAF 1002, one or more of the data sources 1004, the DPC 1006, the NEF 1008, and/or the AF DPC 1010 may be the same as or in accordance with any of the UEs described herein. For example, one or more of the data sources 1004 may be the same as the UE 200 shown in FIG. 2 and described in more detail earlier above.

In this embodiment, it may be the case that the NWDAF 1002 has received a request to retrain a specific Analytics ID and AI/ML model. The NWDAF 1002 in this case also holds a logical DP functionality, while the corresponding control, i.e., DPC 1006, is a separate entity, either realized as a NF or as a logical NF collocated at a 3rd party AF. The method 1000 comprises the following steps.

At step 1012, the logical DP (in the NWDAF 1002) collects the data from the respective data sources 1004 based on the Analytics ID and AI/ML model included the request received for AI/ML re-training.

At step 1014, the logical DP then performs the analysis of data for information extraction to derive the data characteristics and explore the data to identify if the collected data faces quality issues or irregularities.

After 1014, the logical DP requests and receives control information related to the data preparation from the respective DPC 1006.

Two different cases are now considered depending on where the DPC 1006 resides. Specifically, if the DPC 1006 resides on a trusted entity, the method proceeds with steps 1016 and 1018; after step 1018 the method continues to step 1030. On the other hand, if the DPC 1006 resides on an untrusted entity, the method proceeds with steps 1020 to 1028; after step 1028 the method continues to step 1030.

The DPC 1006 may be considered a trusted DPC when it resides in the network operator premises. On the other hand, the DPC 1006 may be considered an untrusted DPC when it resides outside the network operator premises.

Considering first the case where the DPC 1006 resides on a trusted entity, at step 1016, the logical DP issues a request, Ndpc_DPControl_Request, to the DPC 1006. This may be performed in the same way as at step 826 of the method 800, as described earlier above with respect to FIG. 8.

At step 1018, the DPC 1006 sends a response, Ndpc_DPControl_Notify, to the logical DP. This may be performed in the same way as at step 828 of the method 800, as described earlier above with respect to FIG. 8.

After step 1018 the method continues to step 1030.

Considering now the case where the DPC 1006 resides on an untrusted entity, at step 1020, the logical DP issues a request, Ndpc_DPControl_Request, towards the DPC 1006. This may be performed in the same way as at step 830 of the method 800, as described earlier above with respect to FIG. 8.

At step 1022, the NEF 804 controls the exposure of the Ndpc_DPControl_Request. This may be performed in the same way as at step 832 of the method 800, as described earlier above with respect to FIG. 8.

At step 1024, the NEF 804 forwards the Ndpc_DPControl_Request that contains now abstracted data to the corresponding AF DPC 1010. This may be performed in the same way as at step 834 of the method 800, as described earlier above with respect to FIG. 8.

At step 1026, the AF DPC 1010 responds to NEF 1008 with a Ndpc_DPControl_Notify message. This may be performed in the same way as at step 836 of the method 800, as described earlier above with respect to FIG. 8.

At step 1028, the NEF 1008 performs the mapping and forwards the Ndpc_DPControl_Notify to the logical DP. This may be performed in the same way as at step 838 of the method 800, as described earlier above with respect to FIG. 8. After step 1028 the method continues to step 1030.

At step 1030, the logical DP then prepares the data based on the DPC input. This may include performing data recovery, cleaning, formatting, and/or preparing the data sets for training.

After step 1030, the logical DP then prepares the data quality report to share with the DPC, informing it on the result of its suggestions. In this embodiment, the data quality report is disseminated differently depending on whether the DPC 1006 is trusted or un-trusted. Specifically, if the DPC 1006 resides on a trusted entity, the method proceeds with step 1032. On the other hand, if the DPC 1006 resides on an untrusted entity, the method proceeds with steps 1034 and 1036.

Considering first the case where the DPC 1006 resides on a trusted entity, at step 1032, the logical DP issues a Ndpc_DPControl_Report towards the DPC 1006. This may be performed in the same way as at step 842 of the method 800, as described earlier above with respect to FIG. 8.

Considering next the case where the DPC 1006 resides on an untrusted entity, at step 1034, the logical DP issues a Ndpc_DPControl_Report towards the NEF 1008. This may be performed in the same way as at step 844 of the method 800, as described earlier above with respect to FIG. 8.

At step 1036, the NEF 1008 exposes the data performing an abstraction to remove network operator specific information and forwards the Ndpc_DPControl_Report towards the respective AF DPC 1010. This may be performed in the same way as at step 846 of the method 800, as described earlier above with respect to FIG. 8.

Thus, a third embodiment of a method 1000 of data preparation for analytics data in the 3GPP architecture is provided.

In an embodiment, there is provided a data preparation function in a wireless communication network. The data preparation function comprises one or more processors arranged to: collect data from one or more data sources in the wireless communication network; analyse the collected data to derive one or more data characteristics and to identify whether the collected data face one or more quality issues or irregularities; and prepare the collected data based on the analysis. The preparing of the collected data comprises performing one or more of the following: data recovery to recover data missing from the collected data; data cleaning of the collected data; formatting of the collected data; or separation of the collected data into different data sets for one or more training tasks.

Deriving one or more data characteristics may comprise determining one or more data characteristics selected from the group of characteristics consisting of:
a central tendency of the collected data;
a variation of the collected data;
a relative effect among variables or features, e.g., how the values of one variable or feature changes in relation with another; and
an amount of data adequate for a requested task, e.g., a task associated with an Analytics ID.

Identifying whether the collected data face one or more quality issues or irregularities may comprise identifying whether the collected data comprise one or more of the following:
an anomaly, e.g., due to errors in a data source such as faults, security incidents, or data transfer errors;
a missing value, e.g., in terms of the percentage per feature or with respect to a specific value range, or other data conditions, and/or in terms of reasoning, including integration errors or processing errors if data preparation needs to generate new values to allow usage of the AI/ML algorithm, or indicate data unavailability from data sources;
irregular cardinality, e.g. where there is a need to check for: a) feature errors (e.g., different data sources may indicate the same feature using different names or IDs), b) impractical features (e.g., with value of 1, and/or a feature that is identified by a developer but has no practical meaning for the AI/ML algorithm), and/or c) data that concentrate only on a particular range; or
an outlier, i.e. data that characterizes values beyond the expected range considering values that are: a) valid, i.e., correct values, but very different from what expected, or b) invalid, i.e., incorrect noise values that are inserted due to an error.

The data recovery may comprise one or more of the following:
recovering missing data from a different data source, i.e., a data source that is different to the initial data source from which that data was previously requested/attempted to be retrieved;
replacing the missing data by other data, which may be from the same or a different data source; and/or
augmenting existing data to account for the missing data.

The data recovery may comprise executing a method to augment missing data considering an indicated range and/or a percentage/volume of missing data.

The data cleaning may comprise executing a policy to mitigate against outliers and random errors from the collected data by removing data and/or introducing one or more weights to reduce the impact of outliers and random errors in the collected data.

The preparation of the collected data may comprises determining an expected performance impact and/or a confidence level on an AI/ML model were the prepared data used as an input for said AI/ML model. The performance impact and/or a confidence level may be determined, for example, in cases where input data from a particular data source is still missing, e.g., even after interacting with the DPC, due to incapability of the selected method to retrieve the data.

The formatting of the collected data may comprise converting the collected data into an appropriate format used by an AI/ML model. This may be done by the DP carrying out instructions provided to it by the DPC function.

The separation of the collected data into different data sets for one or more training tasks may further comprises the labeling and preparation of the data sets for inference, training, validation, and/or testing tasks. This may be performed in accordance with the instructions given by the DPC function.

Inference may use the set of all collected data once the data processing is performed. If the training data set comprises a relatively large percentage of the available data, e.g., 80%, or 70%, then the validation and testing data set may comprise 10% to 20% of the available data each, depending on the application. In some embodiments, data may be randomly allocated to a given set (i.e., training, validation, testing data sets). In other embodiments, data may be allocated to specific sets based on a different set of criteria. In some embodiments, training of an AI/ML model is performed using a data set with values in a specific range; validation and testing of the trained model is then performed using data with values in a different range, to check that the training is acceptable.

The data preparation function may further comprise a receiver or interface arranged to receive a data preparation request. The one or more processors may be arranged to perform one or more of the data collection, data analysis, or data preparation, responsive to the data preparation request being received.

The receiver or interface may be arranged to receive the data preparation request from an NWDAF in the wireless communication network.

The data preparation request may comprise one or more attributes selected from the group of attributes consisting of:
an identifier for an analytics service, e.g., an Analytics ID, that is to consume the prepared data;
an AI model that is to use the prepared data;
an ML model that is to use the prepared data;
time scheduling related to a time window of the prepared expected data;
one or more identifiers of the one or more data sources;
a type of data sources for the one or more data sources;
an expected waiting time bound for preparing the data. (When a request is issued, the source of the request may stipulate to the receiver that requested information/data is required within a specific timeframe, e.g., in the next 1 minute for example. In this case the waiting time bound for preparing the data would be 1 minute);
one or more statistical properties of the prepared expected data, such as range, volume, distribution, etc.;
a Subscription Correlation identifier, which may be implemented, for example, in cases where the analytics request/data preparation request is modified;
an indication of the type of processing that the prepared data is expected to undergo when input into an AI/ML model, i.e., the expected processing of data as input to the AI/ML model, i.e., sorted data format, normalization, sampling rate to reduce the data, etc.;
a preferred level of accuracy for the prepared data, e.g., to deal with missing values or outliers; and
an indication of a format for the prepared data, e.g., an indication of a file and/or specific characteristics for the prepared data.

The data preparation function may further comprise a receiver arranged to receive control information related to the preparing of the collected data from a data preparation control function. The one or more processors may be arranged to prepare the collected data based on the received control information.

The one or more processors may be arranged to prepare the collected data based on control information provided by a data preparation control function. Thus, the control information and/or DP controller may control the data preparation processes of the data preparation function.

The control information may specify one or more of the following:
a data recovery and/or cleaning method to be implemented by the data preparation function;
a type of data recovery and/or cleaning method to be implemented by the data preparation function;
a type of data formatting that is to be used by the data preparation function to format the collected data;
the one or more data sources;
how to separate, divide, split, or prepare the collected data into data sets (e.g., non-overlapping data sets);
how to label data that are part of the data sets.

The data preparation function may further comprise a transmitter arranged to transmit a control request, e.g. Ndpc_DPControl_Request. Optionally, the control request may comprise one or more of:
an indication of the one or more data characteristics;
an indication of missing data values from the collected data;
an indication of outliers in the collected data;
an indication of a data simplification method; or
an indication of missing data labels for characterizing the data.

The data preparation function may further comprise a receiver arranged to receive control information. The control information may be received in response to the control request. Optionally, the control information may be comprising one or more of:
an indication of a type of problem with which the control information is concerned, such as missing data values, outliers, etc.;
an indication or specification of a strategy or method for handling the missing data values indicated in the control request;
an indication or specification of a strategy or method for handling the outliers indicated in the control request;
an indication of an accuracy level; or
an indication of a data labelling method.

The control request may be sent to a trusted data preparation function controller. The control information may be received from the trusted data preparation function controller.

The control request may be sent to a NEF arranged to remove and/or abstract network specific information from the control request and to send the control request having the network specific information removed/abstracted to a data preparation function controller (which may be an untrusted controller). The control information may be received from the NEF, the NEF having received the control information from the (e.g., untrusted) data preparation function controller.

The data preparation function may be a standalone network function in the wireless communication network.

Alternatively, the data preparation function may be a logical network function realised as part of a network function in the wireless communication network. The data preparation function may be part of a network function selected from the group of network functions consisting of: an NWDAF; a DCCF, an MFAF, and a DCAF.

In an embodiment, there is provided a data preparation function controller for controlling the data preparation performed by the data preparation function described herein.

The data preparation function controller may be arranged to provide control information for use by the data preparation function. The control information may be for use in the data preparation performed by the data preparation function.

The data preparation function controller may be arranged to perform one or more of the following:
installing, in the data preparation function, a method, algorithm, model, or function for performing the data preparation;
providing, for use by the data preparation function, e.g., via a meta language, a description of a method, algorithm, model, or function for performing the data preparation;
selecting, from a predefined list, a method, algorithm, model, or function for performing the data preparation, and indicating, to the data preparation function, the selected method, algorithm, model, or function;
indicating, to the data preparation function, an assisting tool (e.g., a digital twin) for assisting in the performance of the data preparation.

The data preparation function controller may be implemented as a separate network function to the data preparation function.

Alternatively, the data preparation function controller may be co-located or integrated with the data preparation function.

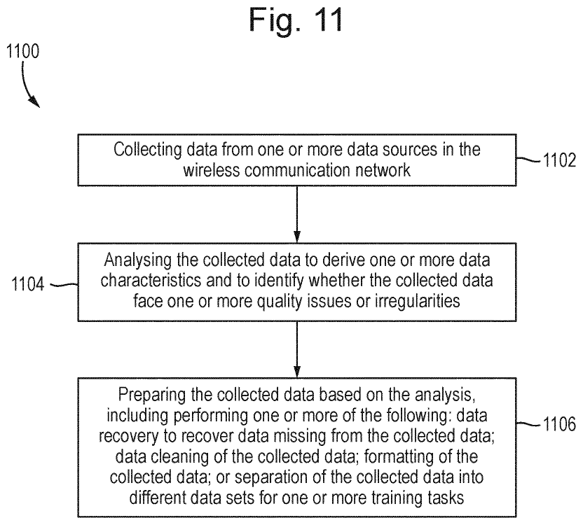

In an embodiment, there is provided a data preparation method performed in a wireless communication network. FIG. 11 is a process flow chart showing certain steps of this method 1100. The method 1100 comprises: collecting 1102 data from one or more data sources in the wireless communication network; analysing 1104 the collected data to derive one or more data characteristics and to identify whether the collected data face one or more quality issues or irregularities; and preparing 1106 the collected data based on the analysis, including performing one or more of the following: data recovery to recover data missing from the collected data; data cleaning of the collected data; formatting of the collected data; or separation of the collected data into different data sets for one or more training tasks.

Data preparation is currently implementation specific based on pre-configuration. This fails to deal with certain problems, while limiting the flexibility when preparing vendor specific data. Existing solutions cannot support any interaction with 5GC NFs, non-3GPP tools, and 3rd parties, e.g., AFs and the OAM. Hence, an analytics consumer (e.g., 3rd party AF) cannot typically get a data insight extracted by analysing the data or regarding data quality issues. Also, an analytics consumer cannot typically indicate how the data preparation needs to be performed to deal with missing data, data cleaning, processing, and formatting, nor suggest how to split data for training, validation, and testing.

The above-described apparatuses and methods advantageously tend to provide for data preparation that allows a flexible way to share and control the data preparation process by 5G core NFs, OAM, AFs (which can also belong to 3rd parties) and non 3GPP tools (e.g., digital twin). Such apparatus defines: i) the DP and DPC as an NF or logical NF (in the 3GPP environment), ii) the interface that allows the control of the DP, and iii) the mechanism that allows communication for the quality control reporting in data preparation.

Conventional solutions are implementation specific and so do not interact with other 5G core NFs (e.g., the NWDAF), OAM, AFs (which can also belong to 3rd parties) and non 3GPP tools (e.g., digital twin). Thus, conventionally, a consumer of analytics cannot influence the data preparation. As mentioned above, data preparation is a significant step for the performance of analytics. The above-described apparatuses and methods advantageously tend to provide an open interface that allows parties to control the data preparation instead of relying on a preconfigured solution. This tends to achieve better analytics results. This tends to be especially useful for 3rd parties that tends to have good knowledge about their own data.

Embodiments described herein advantageously provide a DP and DCP as NFs or logical NFs in 3GPP SBA, the interface that allows data preparation control, and mechanism for data quality control.

Embodiments are provided wherein the NWDAF MTLF, as a consumer of data preparation, relies on a DP function that is a separate entity inside the network operator premises. The DPC is implemented as separate NF either in the same network operator premises or as logical NF collocated with a 3rd party AF.

Embodiments are provided wherein the NWDAF MTLF, as a consumer of data preparation, relies on a DP function that is co-located with the DPC residing in the network operator premises.

Embodiments are provided wherein the NWDAF MTLF containing a logical DP relies on data preparation control by the DPC, which can cither be a separate NF entity in the same network operator premises or a logical NF collocated with a 3rd party AF.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

Further aspects of the invention are provided by the subject matter of the following clauses:

Clause 1. An apparatus for data preparation where a NF or logical NE or application allows another network entity that can be a 5G core NFs, the OAM or 3rd party to perform monitoring and control related to the process of data preparation, by the means of (i) installing, or (ii) describing via meta language, or (iii) selecting out of a predefined list, or (iv) pointing to an assisting tool or sandbox that simulates, an assisting method to accomplish this.

Clause 2. The apparatus of any preceding clause, where data quality issues can be regulated for a particular Analytics ID, AI/ML model or for a specific, e.g., application (for QoE) or geographical area or UE(s), instructing the adoption of different algorithms/models, mechanisms, and tools to deal with data preparation.

Clause 3. The apparatus of any preceding clause, where a data processing function or logical data processing function can include at least one of the following operations i) select data sets, ii) analyse data for information extraction, iii) perform data exploration to identify data quality issue and irregularities, iv) data processing and formatting, and v) prepare data sets of training.

Clause 4. The apparatus of any preceding clause, where a data processing control function or logical data processing control function can include at least one of the following operations i) data recovery and cleaning, ii) simplifying data, iii) perform data formatting and iv) prepare the non-overlapping data sets for the purpose of training, including data labelling.

Clause 5. A method that allows a data analytics training function to request data preparation that is performed and controlled with the assistance of a 3rd party AF.

Clause 6. A method that allows a data processing function and a data processing control function to register to a discover repository indicating their capabilities or as a capability of the NF that is co-located.

Clause 7. A method that allows an analytics function to request data preparation by indicating at least one of the following Analytics ID, Time schedule, identifiers of the data sources, statistical properties of the expected data, expected processing of data, the preferred level of accuracy dealing with missing values and indicate the format of the prepared data.

Clause 8. A method that allows a data preparation control function to notify on the strategy dealing with missing data and other irregularities, provision or indication of the processing method, labelling of data and preparation of data sets.

Clause 9. A method that allows the data processing to provide a report to the data processing control including indication how it dealt with missing values, confidence in providing missing values, the policy adopted for outliers, the percentage of the data that is fixed by the suggestions, the labelling accuracy, and the timestamp.

The following abbreviations are relevant in the field addressed by this document:
3GPP 3rd Generation Partnership Project
5G 5th Generation of Mobile Communication
AI/ML Artificial Intelligence/Machine Learning
ADRF Analytical Data Repository Function
AF Application Function
AnLF Analytics Logical Function
CM Configuration Management
DCAF Data Collection Application Function
DCCF Data Collection Coordination Functionality
DP Data Preparation
KPI Key Performance Indicator
MF Management Function
MFAF Messaging Framework Adaptor Function
MICO Mobile Initiated Connection Only
MnS Management Service
MTLF Model Training Logical Function
NEF Network Exposure Function
NF Network Function
NRF Network Repository Function
NWDAF Network Data Analytics Function
OAM Operations, Administration and Maintenance
ORAN Open RAN
PM Performance Measurement
QoE Quality of Experience
RAN Radio Access Network
SBA Service Based Architecture
UDM User Data manager
UDR User Data Repository
UE User Equipment

What is claimed is:

1-25. (canceled)

26. A method performed by a first network function (NF), the method comprising:
receiving, from a second NF, a data preparation request comprising a set of attributes, wherein the set of attributes comprises one or more of an identifier for an analytics service to consume prepared data, an identifier for an artificial intelligence (AI) model or an identifier for a machine learning (ML) model to use the prepared data; and
processing, based at least in part on the data preparation request, a data set to generate the prepared data.

27. The method of claim 26, wherein the set of attributes further comprises one or more of:
time scheduling information associated with a time window associated with the prepared data;
one or more identifiers of one or more data sources associated with the data set collected as input to process data;
one or more identifiers related to a statistical property of the data set used as input to process the data set; or
a type of data sources for the one or more data sources associated with the data set used as input to process the data set.

28. The method of claim 26, wherein the set of attributes further comprises one or more of:
a waiting time bound associated with processing the prepared data;
an indication of a type of processing that the prepared data is expected to undergo when input into one or more of the AI model or the ML model; or
accuracy level information for the prepared data.

29. The method of claim 26, wherein processing the data set comprises:
deriving one or more data characteristics of the data set, wherein the one or more data characteristics comprise one or more of:
an effect among variables or features of the data set; or
an amount of data adequate for a requested task.

30. The method of claim 26, wherein processing the data set comprises:
performing data recovery for the data set, wherein the data recovery comprises one or more of:
recovering missing data from a data source or a data production tool;
identifying and replacing invalid data with other data; or
augmenting existing data to account for the missing data.

31. The method of claim 26, wherein the second NF comprises a network data analytics function (NWDAF).

32. The method of claim 26, further comprising:
receiving, from a data preparation control function, control information associated with processing the data set, wherein processing the data set is based at least in part on the received data preparation request.

33. The method of claim 32, wherein the control information comprises one or more of:
a type of data recovery rules or logic for the data set;
a type of data cleaning rules or logic for the data set;
a type of data formatting rules or logic for formatting the data set;
one or more additional data sources to complement the data set; or
information for labeling the data associated with different data sets.

34. The method of claim 26, further comprising:
transmitting, to the second NF, a control request comprising one or more of:
an indication of one or more data characteristics of the data set;
an indication of one or more missing data values from the data set;
an indication of one or more outliers in the data set;
an indication of a data simplification method; or
an indication of missing or erroneous data labels for characterizing the data set; and
receiving, based at least in part on the control request, control information comprising one or more of:
an indication of a type of problem associated with the control information;
information for handling the one or more missing data values from the data set;
information for handling the one or more outliers in the data set;
an indication of an accuracy level for processing the data set; or
an indication of a data labeling method for processing the data set.

35. The method of claim 34, wherein the control request is transmitted to a data preparation function controller, and the control information is received from the data preparation function controller.

36. The method of claim 34, wherein the control request is transmitted to a network exposure function (NEF), and the control information is received from the NEF.

37. A first network function (NF) for wireless communication, comprising:
at least one memory; and
at least one processor coupled with the at least one memory and operable to cause the first NF to:
receive, from a second NF, a data preparation request comprising a set of attributes, wherein the set of attributes comprises one or more of an identifier for an analytics service to consume prepared data, an identifier for an artificial intelligence (AI) model or an identifier for a machine learning (ML) model to use the prepared data; and
process, based at least in part on the data preparation request, a data set to generate the prepared data.

38. The first NF of claim 37, wherein the set of attributes further comprises one or more of:
time scheduling information associated with a time window associated with the prepared data;
one or more identifiers of one or more data sources associated with the data set collected as input to process data;
one or more identifiers related to a statistical property of the data set used as input to process the data set; or
a type of data sources for the one or more data sources associated with the data set used as input to process the data set.

39. The first NF of claim 37, wherein the set of attributes further comprises one or more of:
a waiting time bound associated with processing the prepared data;
an indication of a type of processing that the prepared data is expected to undergo when input into one or more of the AI model or the ML model; or
accuracy level information for the prepared data.

40. The first NF of claim 37, wherein to process the data set, the at least one processor is operable to cause the first NF to:
derive one or more data characteristics of the data set, wherein the one or more data characteristics comprise one or more of:
an effect among variables or features of the data set; or
an amount of data adequate for a requested task.

41. The first NF of claim 37, wherein to process the data set, the at least one processor is operable to cause the first NF to:
perform data recovery for the data set, wherein the data recovery comprises one or more of:
recovering missing data from a data source or a data production tool;
identifying and replacing invalid data with other data; or
augmenting existing data to account for the missing data.

42. The first NF of claim 37, wherein the at least one processor is operable to cause the first NF to:
receive, from a data preparation control function, control information associated with preparation of the data set, wherein the data set is processed based at least in part on the received data preparation request.

43. The first NF of claim 42, wherein the control information comprises one or more of:
a type of data recovery rules or logic for the data set;
a type of data cleaning rules or logic for the data set;
a type of data formatting rules or logic for formatting the data set;
one or more additional data sources to complement the data set; or
information for labeling the data associated with different data sets.

44. A method performed by a second network function (NF), the method comprising:
transmitting, to a first NF, a data preparation request comprising a set of attributes, wherein the set of attributes comprise one or more of an identifier for an analytics service to consume prepared data, an identifier for an artificial intelligence (AI) model or an identifier for a machine learning (ML) model to use the prepared data; and
receiving, from the first NF, the prepared data, wherein the prepared data is based at least in part on the data preparation request.

45. A second network function (NF) for wireless communication, comprising:
at least one memory; and
at least one processor coupled with the at least one memory and operable to cause the second NF to:
transmit, to a first NF, a data preparation request comprising a set of attributes, wherein the set of attributes comprise one or more of an identifier for an analytics service to consume prepared data, an identifier for an artificial intelligence (AI) model or an identifier for a machine learning (ML) model to use the prepared data; and
receive, from the first NF, the prepared data, wherein the prepared data is based at least in part on the data preparation request.
